(19) United States
(12) Patent Application Publication
(10) Pub. No.: US 2006/0243400 A1
(43) Pub. Date: Nov. 2, 2006

(54) Hurricane and burglar deterrent for garage doors

(76) Inventor: George Becka JR., North Royalton, OH (US)

Correspondence Address: John M Skeriotis;Brouse McDowell, LPA, Ste. 500, 388 S. Main Street, Akron, OH, 44311-4407, US

(21) Appl. No.: 11/118,789

(22) Filed: Apr. 29, 2005

(51) Int. Cl. E05D 15/00

(52) U.S. Cl. 160/201

(57) ABSTRACT

A hurricane and burglar deterrent system that is utilized inside a garage having a garage door. Support members attached to the upper wall of the garage. The lower end of the support members are attached to the garage floor are installed only when the garage door is closed. The support members can be vertically, horizontally, diagonally or a combination of the aforementioned arrangements to the garage door via a fixed attachment. There can also be at least one removable bolt to secure the support members to the floor of the garage.

### I. BACKGROUND OF THE INVENTION

A. Field of Invention

This invention relates to a device to prevent damage caused by hurricanes and, more particularly, a supporting structure for use with garage doors to prevent the collapse of a garage door due to strong winds typically occurring during hurricane season.

B. Description of the Related Art

It is known in the art for hurricanes, tornadoes, and the like to produce strong winds, rain, that cause damage to homes, automobiles, and any other item that comes in their path. Each year there are thousands of homes, mainly, in the coastal areas, that incur damage due to wind storms. The swirling winds often cause roof tops to be removed, homes to collapse; the contents of which are destroyed. The coastal areas often prepare for the hurricane season by taking a number of preventive steps to minimize damage as much as possible. Individuals often seek shelter in the basements or otherwise leave their home during the most dangerous of times.

Among the deterrent systems used are storm systems which are placed against windows on the outside of a structure. These support systems generally cover the outside of the window to minimize breakage of the window due to strong winds. Attachments to these windows can range from exorbitant systems to simply nailing a piece of plywood to cover the window. Nevertheless, these supporting structures all intend to minimize the damage and otherwise not allow the strong winds to enter through a broken window. If the strong winds are able to enter the structure, the damage can be immeasurable and may even collapse the structure.

A supporting structure that can withstand strong winds are acceptable for areas that have glass, i.e. a window. There is not an appropriate support structure for the garage door. Garage doors are typically made up of fiberglass or other light material due to adoption and widespread use of garage door opening systems. Since the average garage door opening system utilizes a small motor, a garage door itself cannot be very heavy. Thus, garage doors must be light yet have the ability to withstand strong winds caused from hurricanes, tornadoes, and the like.

During hurricane season, i.e., where the garage door is not properly able to withstand the strong winds associated therewith, the garage door collapses inwardly. Hurricanes tend to occur along the coast lines and these homes are typically used as vacation resorts or summer homes. Due to this, automobiles are often stored in the garages. Other valuables are also stored in the garage. Other high cost items are typically stored in the garage. Where the garage door does buckle, burglars enter the garage door and steal the automobiles, and the other homeowner valuables out of the garage. Therefore, there is a need to provide stability to garage doors to avoid destruction of the garage door due to inclement weather.

### II. SUMMARY OF THE INVENTION

What is disclosed is a hurricane and burglar deterrent system that is utilized inside a garage having a garage door. The garage door has a top, a middle, a bottom, a length and a width. The garage has a defined upper wall and a floor.

There are a plurality of support members. Each one of the plurality of support members has a top and bottom. The top of the plurality of support members are attached to the upper wall of the garage. The bottom of the plurality of support members are attached to the garage floor when the garage door is closed. The plurality of support members are vertically attached to the garage door via a plurality of first attachment means. The plurality of first attachment means are in series with one another and equally spaced apart from one another. The plurality of support members are also equally spaced apart from one another.

There are a plurality of second attachment means. The second attachment means are rigidly attached to the upper wall of the garage. Each one of the plurality of second attachment means are attached to at least one of the plurality of support members which are then attached to the upper wall of the garage.

There is also at least one removable bolting means. The removable bolting means is attached to the floor of the garage. The removable bolting means attaches at least of the plurality of support members to the garage floor.

Additionally, because garage doors are so light, and the fact that individuals who have two homes often are absent, there is a need to secure the garage door from burglars.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a front view from inside a garage, with a garage door in the closed position, showing the hurricane and burglar deterrent system installed;

FIG. 2 is a perspective view from inside the garage, with the garage door in a closed position, having the hurricane and burglar deterrent system installed;

FIG. 3 is a perspective view from inside the garage, with the garage door in an open position, without the hurricane and burglar deterrent system support members installed;

FIG. 4 is a view showing the top of the hurricane and burglar deterrent system in an installed position; and,

FIG. 5 shows a lower locking means utilized in the preferred embodiment.

### IV. DESCRIPTION OF THE PREFERRED EMBODIMENT

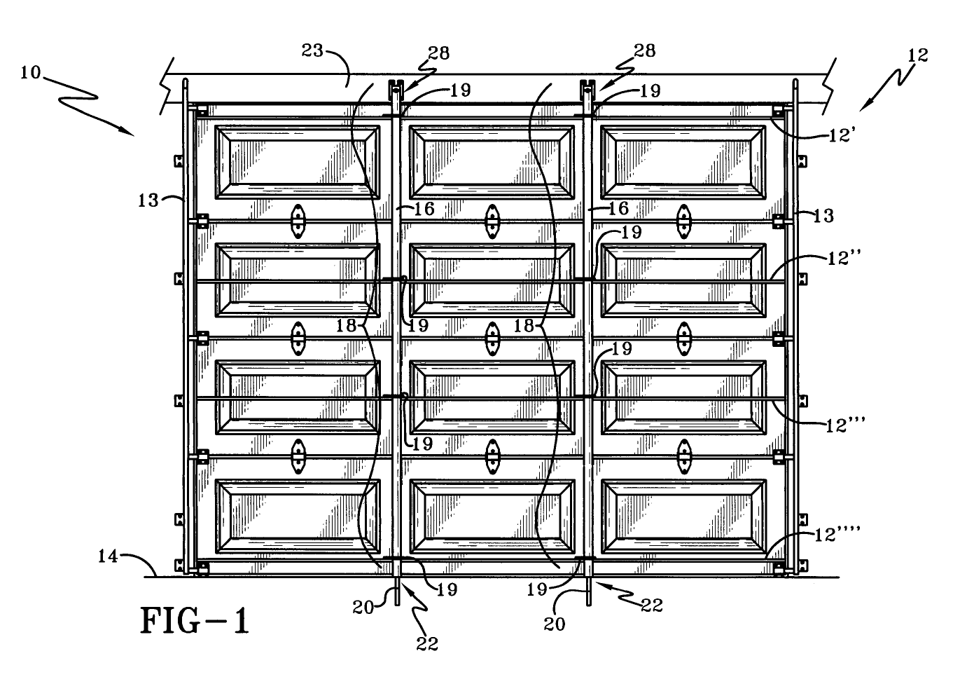

Referring now to the drawings wherein the showings are for purposes of illustrating a preferred embodiment of the invention only and not for purposes of limiting the same, FIG. 1 is a view from inside a garage (not referenced) showing the hurricane and burglar deterrent system 10 in an installed position with a garage door 12 in a closed position. The hurricane and burglar deterrent system 10 is mounted upon a garage door 12. With the garage door 12 in the closed position (whereby it contacts a ground 14) at least one support member 16 is attached to the garage door 12. In the preferred embodiment, the support member 16 will be two support members for a standard eighteen foot wide garage door. However, it is within the scope of this invention to have a plurality of support members 16, or, possibly one support member 16. In the preferred embodiment, the support members 16 are attached vertically to the garage door 12. The support members 16 may be arranged horizontally, diagonally or at angles with respect to one another or to the garage door. The plurality of support members 16 may also be a combination of vertical, horizontal and diagonal. In the preferred embodiment, the support members 16 are equally spaced apart from one another with respect to ends 13 of the garage door 12. However, they may be spaced apart from one another any distance whatsoever.

In the preferred embodiment, the support members 16 are vertically attached to the garage door 12 by a series of attachment means 18. Any means 18 utilized to attach the support members 16 to the garage door may be utilized. In the preferred embodiment, the series of attachment means 18 secure the support members 16 to a garage header 23 at the top of the garage door 12′. The series of attachment means 18 continue vertically downward to middle sections 12″″, of the garage door 12 all the way to the bottom or lowest portion 12″″. At the lowermost portion, the series of attachment means 18 attach into the ground 14 which is typically a concrete or asphalt floor 14. Various methods to attach the support members 16 can be utilized and still be within the scope of this invention. For example, the support members 16 may only be attached to the upper garage header 23 of the garage and also attached to the ground 14. That may serve to aid the garage door from being dislodged. However, the preferred embodiment is to have the support members 16 attached to the garage door 12, the garage header 23 and the ground 14 simultaneously.

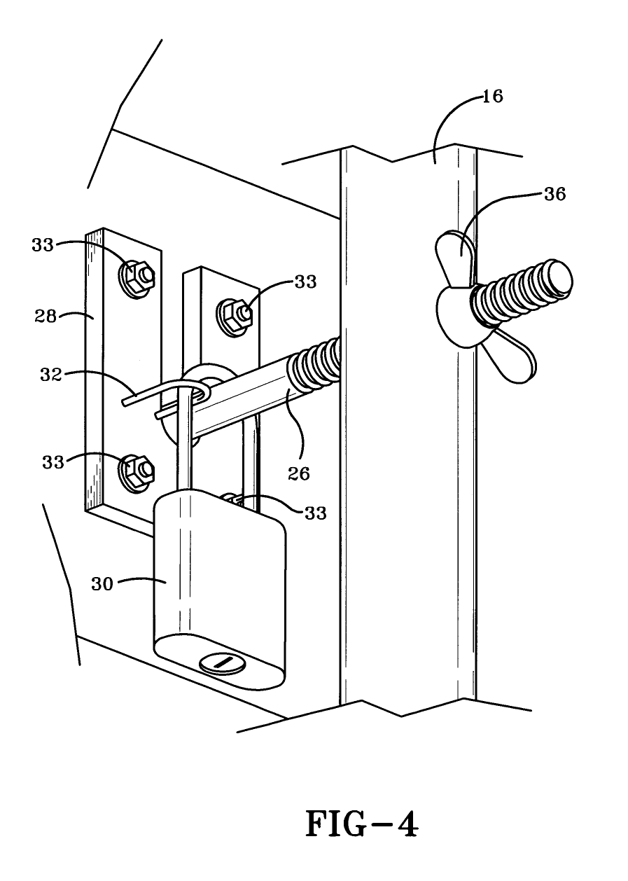

With reference to FIGS. 1, 2 and 4, the series of attachment means 18 and, more particularly, the upper attachment means will now be discussed. In its preferred embodiment, the upper attachment means serves to rigidly attach the support member 16 to the garage header 23. This is accomplished by a bracket 28 that is attached by attachment means 33 to the garage header 23. In the preferred embodiment, the attachment means are four screws that rigidly secure the bracket 28 to the garage header 23. Any attachment means that will allow the bracket 28 to be attached to the wall is within the scope of this invention. The bracket 28 serves the purpose of aiding the fixed attachment of the support members 16 to the garage header 23. The garage header 23 is typically made out of drywall or similar non-rigid material. Preferably the bracket 28 is made out of steel, plastic, or other firm rigid material. The support member 16 is attached to the garage header 23 and bracket 28 via screw 26 and wing nut 36. Screw 26 is a part of the series of attachment means 18. The screw 26 passes through a hole in the support member 16 through an opening in bracket 28 and secures to the garage header 23. To ensure that the screw 26 will not disengage from the bracket 28 the wing nut 36 is there to secure it. In order to assure that screw 26 will not disengage from the garage header 23, an optional lock 30 engages with an optional attachment member 32 that is affixed to bracket 28.

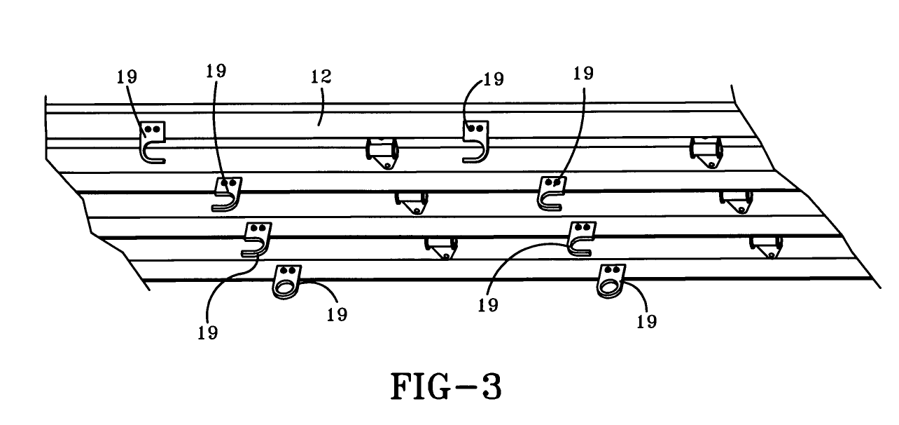

With reference to FIGS. 1, 2 and 3, the series of attachment means 18 includes a U-shaped member 19. The U-shaped member 19 is located at various intervals vertically along the length of the support member 16. In the preferred embodiment, there are a plurality of U-shaped members 19 and, preferably four support members 16. The U-shaped member 19 encompasses the support member 16 to hold it in place against the garage door 12. The U-shaped member 19 is attached via screws to the garage door. Any method of attachment can be utilized to attach the U-shaped member 19 to the garage door 12. Additionally, the U-shaped member can be optional as described supra if the support member 16 is merely attached to the garage header 23 and ground 14. The U-shaped member 19 can also be entirely closed yet still have an opening to receive the support member 16.

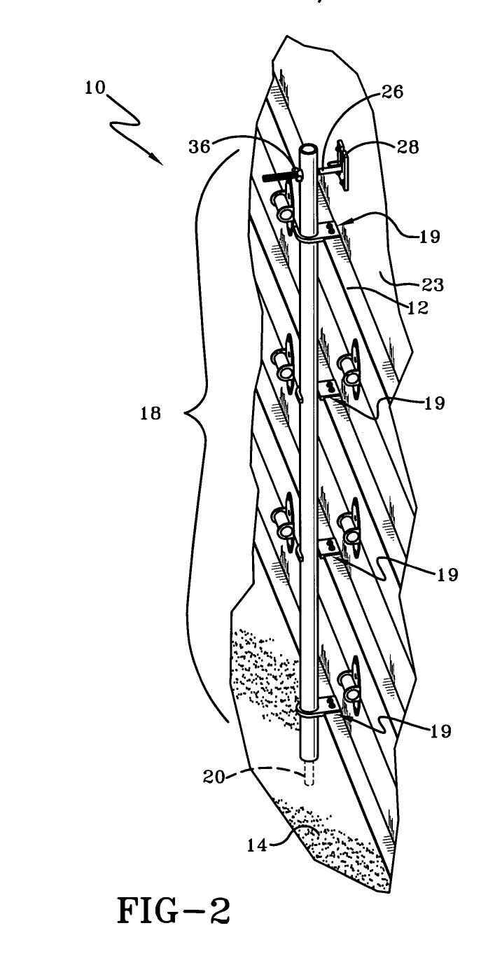

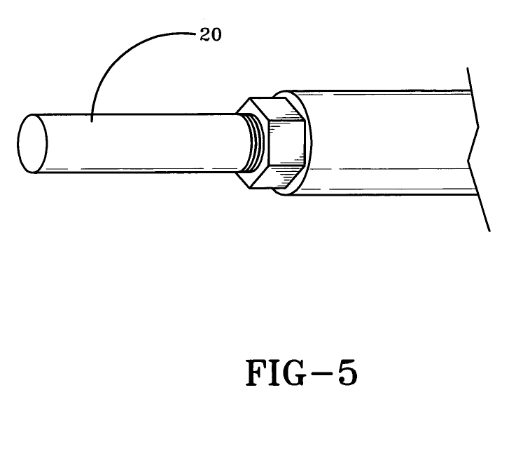

Turning now to the last series of attaching means 18, in its preferred embodiment, and with respect to FIGS. 1, 2 the lower series of attachment means 18 is shown. The lower series of attachment means 18 comprises pre-drilling a hole into the ground 14 to accept a bolting means 20, an example of which is shown in FIG. 5. The bolting means 20 is placed in the ground 14 and secures the support member 16 to the ground. Obviously, a variety of methods to attach the supporting member 16 to the ground can be accomplished. When not in use, a plastic cap can be installed into the ground 14 to ensure water, debris, etc., do not enter.

In use, the support member 16 slides through the series of attachment means 18, the U-shaped members 19. The bolting means 20 is attached to the ground 14. Thereafter, the support members 16 are fixed to the bolting means 20. The screw 26 is inserted into the top portion opening of support member 16 and travels through bracket 28 and into garage header 23. It is thereafter secured by wing nut 36. The entire assembly of the hurricane and burglar deterrent system 10 can be mounted, dismounted within five minutes or less.

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

Having thus described the invention, it is now claimed:

1. A hurricane and burglar deterrent system for a garage having a closed garage door with a top, a middle, a bottom, having a length and a width, the garage having an upper wall and a floor, said hurricane and burglar deterrent system comprising:
at least one support member, said at least one support member having a top and bottom, said top of said at least one support member being attached to the upper wall of the garage, said bottom of said at least one support member being attached to the garage floor.

2. The hurricane and burglar deterrent system as claimed in claim 1, wherein said at least one support member is attached to the garage door.

3. The hurricane and burglar deterrent system as claimed in claim 1, wherein said at least one support member extends vertically from the top to the bottom of the garage door.

4. The hurricane and burglar deterrent system as claimed in claim 1, wherein said at least one support member extends diagonally from the top to the bottom of the garage door.

5. The hurricane and burglar deterrent system as claimed in claim 1, wherein said at least one support member extends horizontally across the garage door.

6. The hurricane and burglar deterrent system as claimed in claim 1, wherein said at least one support member comprises a plurality of support members.

7. The hurricane and burglar deterrent system as claimed in claim 2, wherein said at least one support member is attached to said garage door via at least one attachment means along the length of the garage door.

8. The hurricane and burglar deterrent system as claimed in claim 2, wherein said at least one support member is attached to said garage door via at least one attachment means along the width of the garage door.

9. The hurricane and burglar deterrent system as claimed in claim 2, wherein said at least one support member is attached via a series of attachment means running along the length of the garage door.

10. The hurricane and burglar deterrent system as claimed in claim 6, wherein said plurality of support members are equally spaced apart from one another along the width of the garage door.

11. The hurricane and burglar deterrent system as claimed in claim 1, wherein said bottom of said at least one support member is attached to the garage floor via an attachment means.

12. A hurricane and burglar deterrent system comprising:
a garage having garage door, said garage door having a top, a middle, a bottom, and a length and a width, the garage having an upper wall and a floor;
at least one support member, said at least one support member having a top and bottom, said top of said at least one support member being attached to the upper wall of the garage, said bottom of said at least one support member being attached to the garage floor wherein said garage door is closed.

13. The hurricane and burglar deterrent system as claimed in claim 12, wherein said at least one support member is attached to said garage door.

14. The hurricane and burglar deterrent system as claimed in claim 12, wherein said at least one support member extends vertically from the top to the bottom of said garage door.

15. The hurricane and burglar deterrent system as claimed in claim 12, wherein said at least one support member extends diagonally from said top to said bottom of said garage door.

16. The hurricane and burglar deterrent system as claimed in claim 12, wherein said at least one support member extends horizontally across said garage door.

17. The hurricane and burglar deterrent system as claimed in claim 12, wherein said at least one support member comprises a plurality of support members, said support members being equally spaced apart from one another.

18. The hurricane and burglar deterrent system as claimed in claim 13, wherein said at least one support member is attached to said garage door via at least one attachment means along the length of said garage door.

19. The hurricane and burglar deterrent system as claimed in claim 13, wherein said at least one support member is attached via a series of attachment means running along the length of said garage door.

20. A hurricane and burglar deterrent system comprising:
a garage having garage door, said garage door having a top, a middle, a bottom, and a length and a width, the garage having an upper wall and a floor;
a plurality of support members, said plurality of support members each having a top and bottom, said top of said plurality of support members being attached to the upper wall of the garage, said bottom of said plurality of support members being attached to the garage floor wherein said garage door is closed, said plurality of support members vertically attached to said garage door via a plurality of first attachment means, said plurality of first attachment means being in series with one another and equally spaced apart from one another, said plurality of support members being equally spaced apart from one another;
a plurality of second attachment means, said second attachment means being rigidly attached to said upper wall of said garage, each one of said plurality of second attachment means attaching one of said plurality of support members to said upper wall of said garage;
at least one removable bolting means, said removable bolting means being attached to said floor of said garage, said removable bolting means attaching at least of said plurality of support members to said garage floor.
